(19) United States
(12) Patent Application Publication
(10) Pub. No.: US 2015/0117666 A1
(43) Pub. Date: Apr. 30, 2015

(54) PROVIDING MULTICHANNEL AUDIO DATA RENDERING CAPABILITY IN A DATA PROCESSING DEVICE

(71) Applicant: NVIDIA Corporation, Santa Clara, CA (US)

(72) Inventor: Ambrish Dantrey, Pune (IN)

(73) Assignee: NVIDIA Corporation, Santa Clara, CA (US)

(21) Appl. No.: 14/067,997

(22) Filed: Oct. 31, 2013

(51) Int. Cl. H04R 3/00

(52) U.S. Cl. CPC H04R 3/00
USPC 381/80

(57) ABSTRACT

A method includes distinctly assigning, through a driver component, each audio channel of multichannel audio data in a memory of a data processing device to one or more audio endpoint device(s) of a number of audio endpoint devices communicatively coupled to the data processing device. Each audio endpoint device of the number of audio endpoint devices is capable of supporting a number of audio channels less than a number of audio channels of the multichannel audio data. The method also includes routing, through a processor of the data processing device communicatively coupled to the memory, audio data related to the each audio channel to the appropriate one or more audio endpoint device(s) based on the assignment through the driver component to enable rendering of the multichannel audio data on the number of audio endpoint devices.

### FIELD OF TECHNOLOGY

This disclosure relates generally to audio rendering and, more particularly, to a method, a device and/or a system of providing multichannel audio data rendering capability in a data processing device.

### BACKGROUND

A data processing device (e.g., a smart television, a desktop computer, a laptop computer, a notebook computer, a netbook, a mobile device such as a mobile phone) may include a number of audio endpoint device(s) (e.g., a speaker, headphones, earphones, a display unit including one or more speaker(s)) coupled thereto. As each audio endpoint device of the number of audio endpoint device(s) typically supports one or two audio channels, a number of one or two channel audio stream(s) may be rendered through the audio endpoint device(s). However, rendering of multichannel audio data may be beyond a capability of the audio endpoint device(s). A user of the data processing device may, therefore, have to utilize a compatible audio receiver therefor; the requirement of utilization of the compatible audio receiver may inconvenience the user and/or drain monetary resources thereof.

### SUMMARY

Disclosed are a method, a device and/or a system of providing multichannel audio data rendering capability in a data processing device.

In one aspect, a method includes distinctly assigning, through a driver component, each audio channel of multichannel audio data in a memory of a data processing device to one or more audio endpoint device(s) of a number of audio endpoint devices communicatively coupled to the data processing device. Each audio endpoint device of the number of audio endpoint devices is capable of supporting a number of audio channels less than a number of audio channels of the multichannel audio data. The method also includes routing, through a processor of the data processing device communicatively coupled to the memory, audio data related to the each audio channel to the appropriate one or more audio endpoint device(s) based on the assignment through the driver component to enable rendering of the multichannel audio data on the number of audio endpoint devices.

In another aspect, a non-transitory medium, readable through a data processing device and including instructions embodied therein that are executable through the data processing device, is disclosed. The non-transitory medium includes instructions to distinctly assign, through a driver component, each audio channel of multichannel audio data in a memory of the data processing device to one or more audio endpoint device(s) of a number of audio endpoint devices communicatively coupled to the data processing device. Each audio endpoint device of the number of audio endpoint devices is capable of supporting a number of audio channels less than a number of audio channels of the multichannel audio data. The non-transitory medium also includes instructions to route, through a processor of the data processing device communicatively coupled to the memory, audio data related to the each audio channel to the appropriate one or more audio endpoint device(s) based on the assignment through the driver component to enable rendering of the multichannel audio data on the number of audio endpoint devices.

In yet another aspect, a data processing device includes a memory including multichannel audio data, a number of audio endpoint devices, and a processor communicatively coupled to the memory. The driver component is configured to distinctly assign each audio channel of the multichannel audio data in the memory to one or more audio endpoint device(s) of the number of audio endpoint devices. Each audio endpoint device of the number of audio endpoint devices is capable of supporting a number of audio channels less than a number of audio channels of the multichannel audio data. The processor is configured to execute instructions to route audio data related to the each audio channel to the appropriate one or more audio endpoint device(s) based on the assignment through the driver component to enable rendering of the multichannel audio data on the number of audio endpoint devices.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of the data processing device of FIG. 1 including multiple one or two channel audio data stored in a memory thereof.

FIG. 3 is a schematic view of the data processing device of FIG. 1 including multichannel audio data stored in the memory thereof, according to one or more embodiments.

FIG. 4 is a schematic view of interaction between a driver component and a processor of the data processing device of FIG. 1, one or more application(s) executing on the data processing device of FIG. 1, an operating system executing on the data processing device of FIG. 1 and/or one or more audio endpoint device(s) of the data processing device of FIG. 1, according to one or more embodiments.

FIG. 5 is a process flow diagram detailing the operations involved in providing multichannel audio data rendering capability in the data processing device of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a system and/or a device of providing multichannel audio data rendering capability in a data processing device. Although the present embodiments have been described with reference to specific example embodiments, it will be evident that various modifications and changes may be made to these embodiments without departing from the broader spirit and scope of the various embodiments.

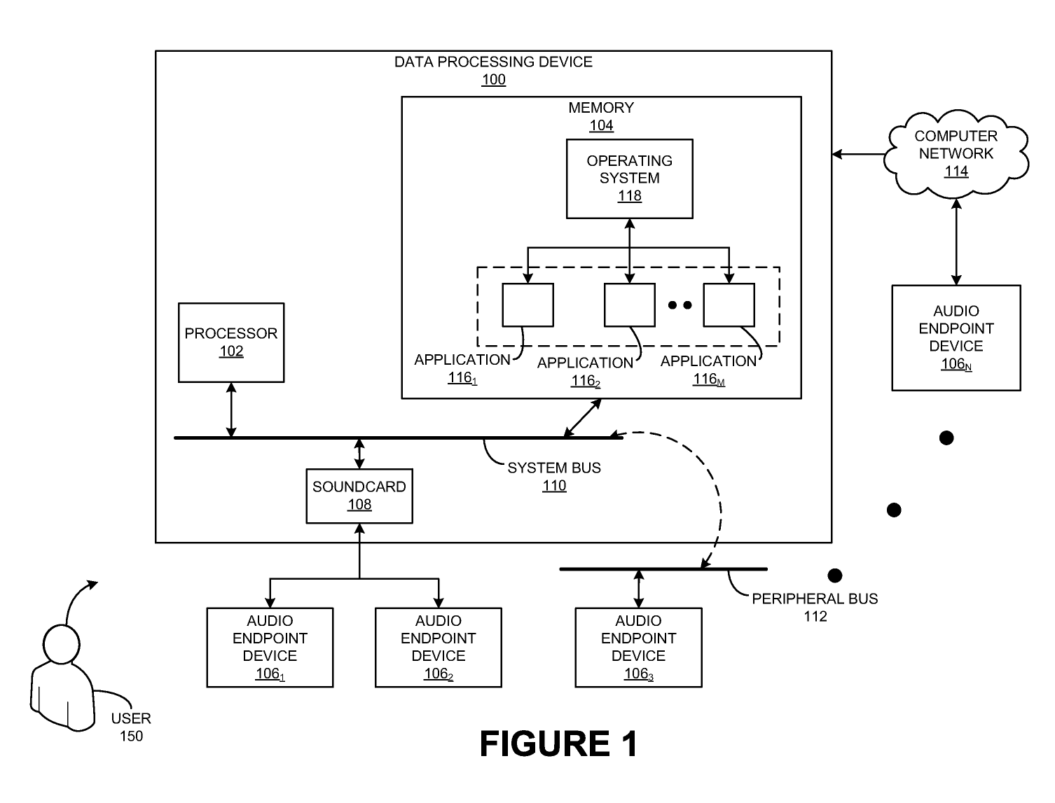

FIG. 1 shows a data processing device 100, according to one or more embodiments. In one or more embodiments, data processing device 100 may include a processor 102 (e.g., a Central Processing Unit (CPU), a Graphics Processing Unit (GPU), a microcontroller) communicatively coupled to a memory 104 (e.g., a volatile memory and/or a non-volatile memory) through a system bus 110; memory 104 may include storage locations configured to be addressable through processor 102. In one or more embodiments, data processing device 100 may be a smart television, a smart media player, a laptop computer, a desktop computer, a notebook computer, a netbook, a tablet or a mobile device such as a mobile phone. Other forms of data processing device 100 (e.g., a standalone microcontroller including processor 102 and memory 104) are within the scope of the exemplary embodiments discussed herein.

In one or more embodiments, data processing device 100 may include a number of audio endpoint devices 106_{1-N} (e.g., speakers, headphones/earphones, display units such as High Definition televisions (HDTVs) including or associated with speakers/headphones/earphones) related to one or more application(s) 116_{1-M} (shown as being stored in memory 104) executing thereon. Audio endpoint devices 106_{1-N} may be interfaced with a soundcard 108 coupled to system bus 110, interfaced with a peripheral bus 112 (or, Input/Output (I/O) bus; Universal Serial Bus (USB) may be an example peripheral bus 112) or coupled to data processing device 100 through a computer network 114 (e.g., Internet, a Wide Area Network (WAN), a Local Area Network (LAN)). FIG. 1 shows one or more audio endpoint devices 106_{1-N} of all of the aforementioned types. Other forms of audio endpoint devices 106_{1-N} applicable to the concepts to be discussed herein are within the scope of the exemplary embodiments.

In one or more embodiments, data processing device 100 may execute an operating system 118 thereon. FIG. 1 shows operating system 118 as being part of memory 104 and interfaced with the one or more application(s) 116_{1-M}. In general, an audio endpoint device 106_{1-N} (e.g., a display unit and/or a pair of speakers) may support only one or two channel audio (e.g., stereo Left (L) and Right (R)) therethrough. When multiple audio endpoint devices 106_{1-N} are utilized in data processing device 100, each audio endpoint device 106_{1-N} may be configured to receive an independent audio stream with one or two channel data.

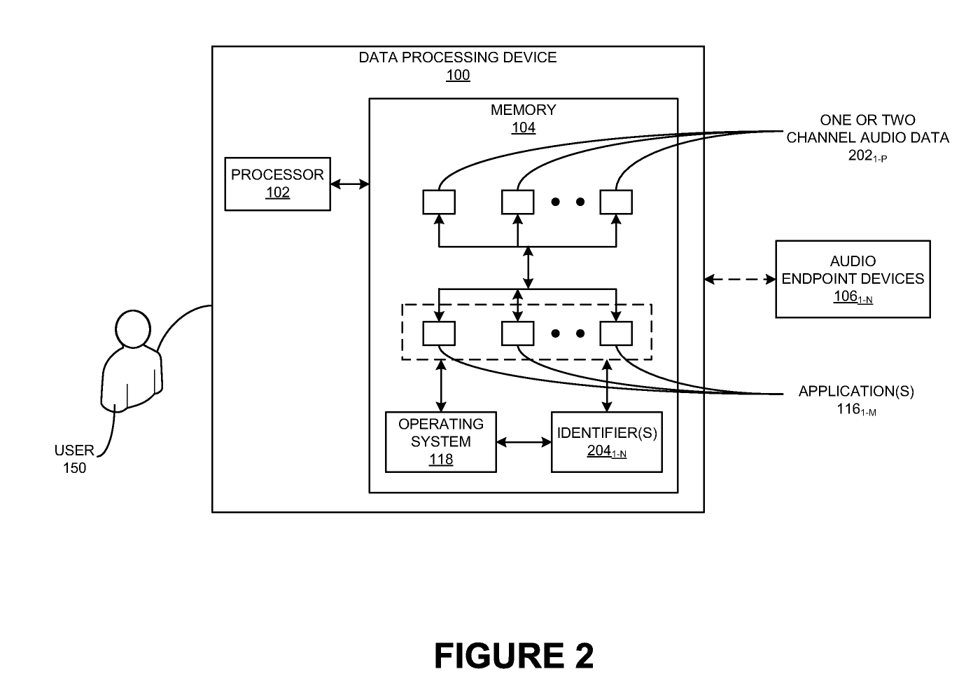

FIG. 2 shows data processing device 100 including multiple one or two channel audio data 202_{1-P} stored in memory 104. It should be noted that the multiple one or two channel audio data 202_{1-P} may be audio streams dynamically generated or pre-stored audio files. A driver component (e.g., a set of instructions that is part of an audio driver component) associated with processor 102, one or more application(s) 116_{1-M} (e.g., an application enabling audio definition(s)/configuration(s)), operating system 118 and/or one or more of audio endpoint device(s) 106_{1-N} may distinctly assign one or two audio endpoint device(s) 106_{1-N} to each one or two channel audio data 202_{1-P}. For example, the assignment may be based on an identifier 204_{1-N} of each audio endpoint device 106_{1-N}. Identifiers 204_{1-N} may be stored in memory 104 (as shown in FIG. 2) or may be accessible based on polling audio endpoint devices 106_{1-N} through processor 102.

Thus, a user 150 of data processing device 100 may be capable of listening to multiple one or two channel audio stream(s) through coupling of audio endpoint devices 106_{1-N} thereto. When data processing device 100 includes multichannel audio data stored in memory 104, rendering of the aforementioned multichannel audio data may be outside a capability thereof. User 150 may, therefore, have to utilize a compatible receiver to which an appropriate number of speakers may be coupled. For example, user 150 may insert a storage medium (e.g., a Digital Video Disc (DVD) disc having multimedia including multichannel audio stored therein) into a DVD player to which the compatible receiver is coupled. The source component, i.e., the DVD player, may transmit a signal to the compatible receiver, which, in turn, may recognize (e.g., through a decoder of the receiver) the different audio channels from the signal and transmit the corresponding audio data to the appropriate speaker(s) coupled thereto.

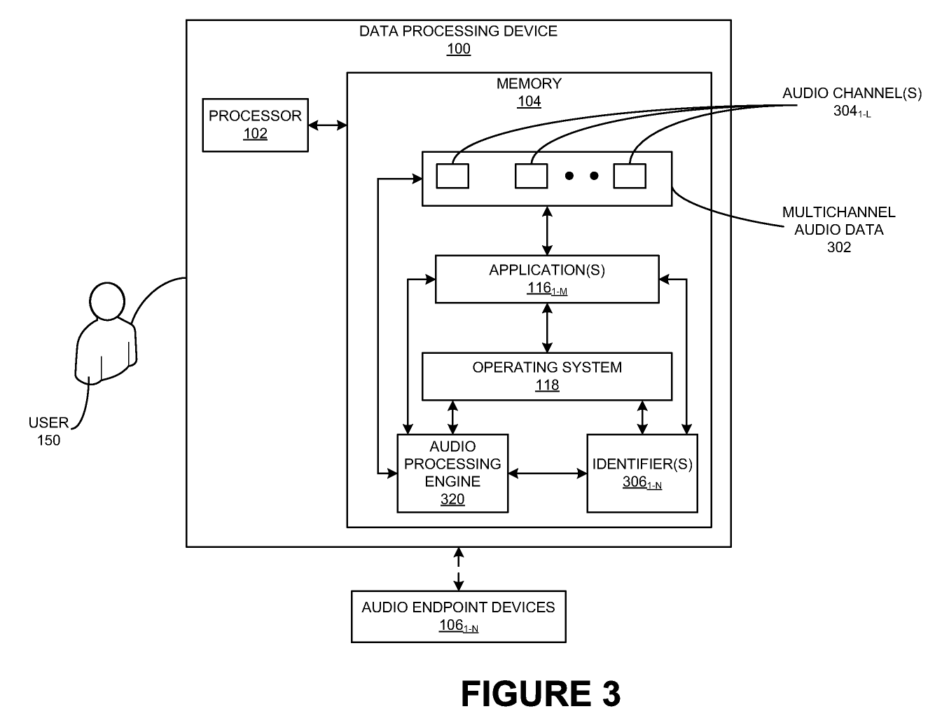

FIG. 3 shows data processing device 100 including multichannel audio data 302 stored in memory 104 (again, can be a pre-stored file or a dynamically generated audio stream), according to one or more embodiments. In one or more embodiments, multichannel audio data 302 may include a number of audio channels 304_{1-L} (or, audio tracks); further, data processing device 100 may include a number of audio endpoint devices 106_{1-N} coupled thereto. For example, audio endpoint devices 106_{1-N} may be speakers (e.g., standalone speakers, speakers that are part of display units) on which multichannel audio data 302 is configured to be rendered.

While the number of speakers (N) is generally equal to the number of audio channels (L), it is obvious that N may be greater than L; here, an L<N number of speakers may be used; alternately, data related to a same audio channel 304_{1-L} may be transmitted to more than one speaker (upon the same audio channel 304_{1-L} being assigned to two speakers; the assignment is discussed herein). Again, in one or more embodiments, a driver component (e.g., a set of instructions that is part of an audio driver component) associated with processor 102, one or more application(s) 116_{1-M} (e.g., an application enabling audio definition(s)/configuration(s)), operating system 118 and/or one or more of audio endpoint devices 106_{1-N} may distinctly assign one or more audio endpoint device(s) 106_{1-N} (e.g., an audio endpoint device having one or two channel capability) to each audio channel 304_{1-L} of multichannel audio data 302. For example, the assignment may be based on an identifier 306_{1-N} of each audio endpoint device 106_{1-N}. Again, in one or more embodiments, identifiers 306_{1-N} may be stored in memory 104 (as shown in FIG. 3) or may be accessible based on polling through processor 102.

Now, in one or more embodiments, as each audio channel 304_{1-L} is associated with one or more audio endpoint device(s) 106_{1-N}, processor 102 may be configured to transmit data related to the each audio channel 304_{1-L} to the corresponding one or more audio endpoint device(s) 106_{1-N} based on the assignment through the driver component. Consider a surround multichannel audio setup with five speakers (example audio endpoint devices 106_{1-N}), viz. a center speaker, a left speaker, a right speaker, a rear left speaker and a rear right speaker. It is obvious that the aforementioned configuration and appropriate placement of the speakers may be crucial to an audio experience of user 150. When the compatible receiver discussed with regard to FIG. 2 is not available to user 150, user 150 may store multichannel audio data 302 in memory 104, as discussed with regard to FIG. 3.

Based on the driver component assignment, one audio channel 304₁₋₅ each of multichannel audio data 302 may be assigned to the center speaker, the left speaker, the right speaker, the rear left speaker and the rear right speaker discussed above. Thus, location of multichannel audio data 302 in memory 104 may be considered as an “audio endpoint” from which processor 102 is configured to route data related to audio channels 304₁₋₅ to the appropriate speakers.

Thus, in one or more embodiments, user 150 may dispense with the need for the compatible receiver discussed above, and may utilize data processing device 100 for multichannel audio data rendering. It should be noted that the compatible receiver discussed above may perform other audio processing functions including but not limited to audio amplification and noise cancelation. In one or more embodiments, the aforementioned functions may be provided as part of an audio processing engine 320. As shown in FIG. 3, audio processing engine 320 may be stored in memory 104 to be executed on processor 102 to enable performing additional processing on multichannel audio data 302. Thus, in one or more embodiments, user 150 may enjoy the benefits of one or more software-implemented functionalities of the compatible receiver discussed above.

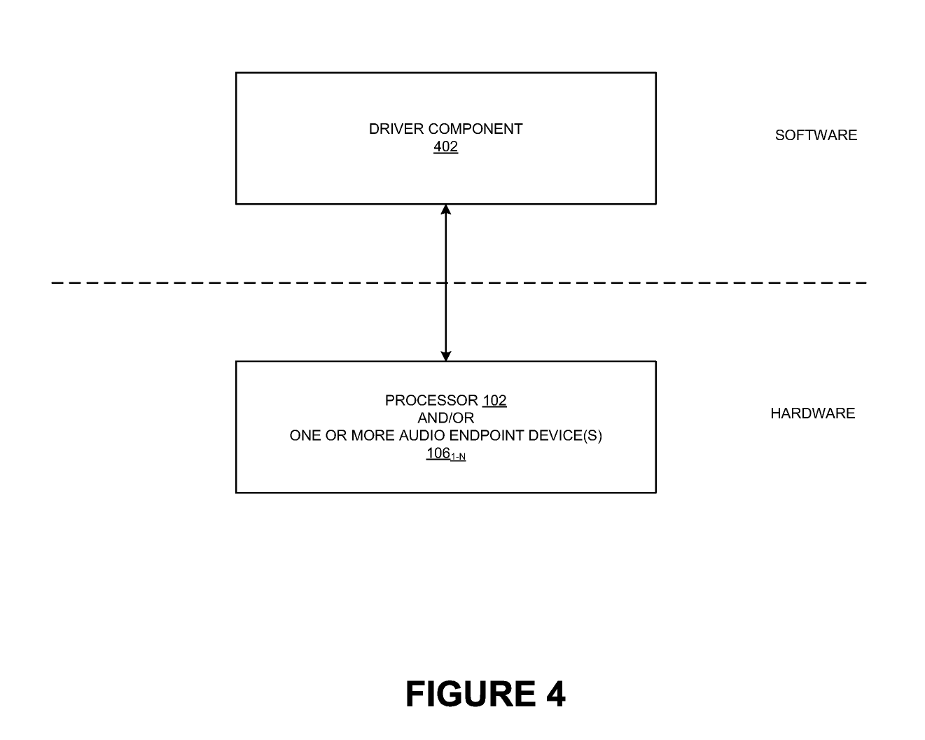

FIG. 4 shows interaction between a driver component 402 and processor 102 and/or one or more audio endpoint device(s) 106_{1-N}, according to one or more embodiments. In one or more embodiments, based on the assignment through driver component 402, processor 102 may be configured to route audio data related to audio channels 304_{1-L} to the appropriate audio endpoint devices 106_{1-N}. In one or more embodiments, driver component 402 may be packaged with the one or more application(s) 116_{1-M} and/or operating system 118. Alternately, driver component 402 may be downloaded from the Internet. Further, instructions associated with driver component 402 and/or applications 116_{1-M} may be embodied on a non-transitory medium (e.g., Compact Disc (CD), DVD, Blu-ray Disc®) readable through data processing device 100 and executable therethrough. All reasonable variations are within the scope of the exemplary embodiments discussed herein.

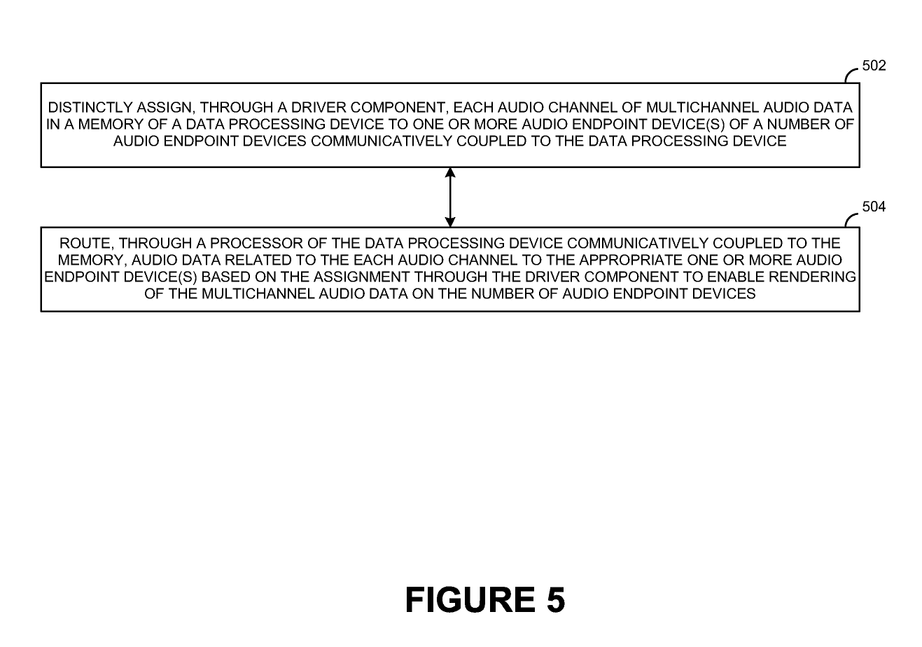

FIG. 5 shows a process flow diagram detailing the operations involved in providing multichannel audio data rendering capability in data processing device 100, according to one or more embodiments. In one or more embodiments, operation 502 may involve distinctly assigning, through driver component 402, each audio channel 304_{1-L} of multichannel audio data 302 in memory 104 to one or more audio endpoint device(s) 106_{1-N} of a number of audio endpoint devices 106_{1-N} communicatively coupled to data processing device 100. In one or more embodiments, each audio endpoint device 106_{1-N} of the number of audio endpoint devices 106_{1-N} may be capable of supporting a number of audio channels less than a number of audio channels of multichannel audio data 302.

In one or more embodiments, operation 504 may then involve routing, through processor 102, audio data related to the each audio channel 304_{1-L} to the appropriate one or more audio endpoint device(s) 106_{1-N} based on the assignment through driver component 402 to enable rendering of multichannel audio data 302 on the number of audio endpoint devices 106_{1-N}.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

What is claimed is:

1. A method comprising:
distinctly assigning, through a driver component, each audio channel of multichannel audio data in a memory of a data processing device to at least one audio endpoint device of a plurality of audio endpoint devices communicatively coupled to the data processing device, each audio endpoint device of the plurality of audio endpoint devices being capable of supporting a number of audio channels less than a number of audio channels of the multichannel audio data; and
routing, through a processor of the data processing device communicatively coupled to the memory, audio data related to the each audio channel to the appropriate at least one audio endpoint device based on the assignment through the driver component to enable rendering of the multichannel audio data on the plurality of audio endpoint devices.

2. The method of claim 1, wherein the driver component is associated with at least one of the processor, at least one application executing on the data processing device, an operating system executing on the data processing device and at least one of the plurality of audio endpoint devices.

3. The method of claim 1, comprising distinctly assigning the each audio channel to the at least one audio endpoint device based on an identifier of the audio endpoint device one of: stored in the memory and obtained through polling the at least one audio endpoint device through the processor.

4. The method of claim 1, wherein when a number of audio endpoint devices is more than the number of audio channels, the method further comprises one of:
utilizing a same number of audio endpoint devices as the number of audio channels; and
assigning, through the driver component, a same audio channel to two audio endpoint devices of the plurality of audio endpoint devices.

5. The method of claim 1, further comprising executing, through the processor, an audio processing engine to perform further processing on the multichannel audio data prior to the routing.

6. The method of claim 2, comprising providing the driver component at least one of: packaged with the at least one application executing on the data processing device and packaged with the operating system executing on the data processing device.

7. The method of claim 1, wherein the multichannel audio data is one of: stored as a file in the memory and dynamically generated at the data processing device.

8. A non-transitory medium, readable through a data processing device and comprising instructions embodied therein that are executable through the data processing device, comprising:
instructions to distinctly assign, through a driver component, each audio channel of multichannel audio data in a memory of the data processing device to at least one audio endpoint device of a plurality of audio endpoint devices communicatively coupled to the data processing device, each audio endpoint device of the plurality of audio endpoint devices being capable of supporting a number of audio channels less than a number of audio channels of the multichannel audio data; and
instructions to route, through a processor of the data processing device communicatively coupled to the memory, audio data related to the each audio channel to the appropriate at least one audio endpoint device based on the assignment through the driver component to enable rendering of the multichannel audio data on the plurality of audio endpoint devices.

9. The non-transitory medium of claim 8, comprising instructions to distinctly assign the each audio channel to the at least one audio endpoint device based on an identifier of the audio endpoint device one of: stored in the memory and obtained through polling the at least one audio endpoint device through the processor.

10. The non-transitory medium of claim 8, wherein when a number of audio endpoint devices is more than the number of audio channels, the non-transitory medium further comprises instructions to one of:
utilize a same number of audio endpoint devices as the number of audio channels; and
assign, through the driver component, a same audio channel to two audio endpoint devices of the plurality of audio endpoint devices.

11. The non-transitory medium of claim 8, further comprising instructions to execute, through the processor, an audio processing engine to perform further processing on the multichannel audio data prior to the routing.

12. The non-transitory medium of claim 8, comprising instructions compatible with the driver component provided at least one of: packaged with at least one application executing on the data processing device and packaged with an operating system executing on the data processing device.

13. The non-transitory medium of claim 8, comprising instructions compatible with the multichannel audio data being one of: stored as a file in the memory and dynamically generated at the data processing device.

14. A data processing device comprising:
a memory comprising multichannel audio data;
a plurality of audio endpoint devices;
a driver component configured to distinctly assign each audio channel of the multichannel audio data in the memory to at least one audio endpoint device of the plurality of audio endpoint devices, each audio endpoint device of the plurality of audio endpoint devices being capable of supporting a number of audio channels less than a number of audio channels of the multichannel audio data; and
a processor communicatively coupled to the memory, the processor being configured to execute instructions to route audio data related to the each audio channel to the appropriate at least one audio endpoint device based on the assignment through the driver component to enable rendering of the multichannel audio data on the plurality of audio endpoint devices.

15. The data processing device of claim 14, wherein the driver component is associated with at least one of the processor, at least one application executing on the data processing device, an operating system executing on the data processing device and at least one of the plurality of audio endpoint devices.

16. The data processing device of claim 14, wherein the driver component is configured to distinctly assign the each audio channel to the at least one audio endpoint device based on an identifier of the audio endpoint device one of:
stored in the memory and obtained through polling the at least one audio endpoint device through the processor.

17. The data processing device of claim 14, wherein when a number of audio endpoint devices is more than the number of audio channels, one of:
a same number of audio endpoint devices as the number of audio channels is utilized, and
the driver component is configured to assign a same audio channel to two audio endpoint devices of the plurality of audio endpoint devices.

18. The data processing device of claim 14,
wherein the memory further comprises an audio processing engine, and
wherein the processor is further configured to execute instructions associated with the audio processing engine to perform further processing on the multichannel audio data prior to the routing.

19. The data processing device of claim 15, wherein the driver component is at least one of: packaged with the at least one application executing on the data processing device and packaged with the operating system executing on the data processing device.

20. The data processing device of claim 14, wherein the multichannel audio data is one of: stored as a file in the memory and dynamically generated at the data processing device.
